(19) United States
(12) Patent Application Publication
(10) Pub. No.: US 2025/0142450 A1
(43) Pub. Date: May 1, 2025

(54) METHOD, DEVICE AND COMPUTER STORAGE MEDIUM OF COMMUNICATION

(71) Applicant: NEC CORPORATION, Tokyo (JP)

(72) Inventor: Gang WANG, Beijing (CN)

(73) Assignee: NEC CORPORATION, Tokyo (JP)

(21) Appl. No.: 18/694,087

(22) PCT Filed: Sep. 22, 2021
(86) PCT No.: PCT/CN2021/119712

§ 371 Date: Mar. 21, 2024

(51) Int. Cl. H04W 48/08; H04W 88/04

(52) U.S. Cl. CPC H04W 48/08; H04W 88/04

(57) ABSTRACT

Embodiments of the present disclosure relate to methods, devices and computer readable media for communication. A first device receives, from a second device, information on modification of system information and determines modified system information to be transmitted to a third device based on a stored request for system information from the third device and the information on modification of system information. Then the first device transmits the modified system information to the third device. In this way, delivery of modified SI for remote UE can be achieved with saved power consumption and signaling overhead.

### TECHNICAL FIELD

Embodiments of the present disclosure generally relate to the field of telecommunication, and in particular, to methods, devices and computer storage media of communication for system information (SI) delivery through sidelink relay.

### BACKGROUND

In context of new radio (NR) sidelink relay, user equipment (UE) that is communicated with a gNB via another UE in coverage (IC) of the gNB is called as remote UE, and the other UE is called as a relay UE. The remote UE may be out of coverage (OoC) of the gNB, and also may be in coverage of the gNB. A connection is established between the remote UE and the relay UE via a sidelink.

In study of sidelink relay, there is a need to specify control plane procedures which include SI delivery. It has been agreed that the remote UE may request SI from the gNB via the relay UE. The relay UE may perform SI acquisition procedure to acquire SI from the gNB and then forward the SI to the remote UE. For SI updating, UE in an idle or inactive state may monitor SI change indication and reacquire modified SI. UE in a connected state may monitor SI change indication or receive dedicated signaling sending from a gNB comprising modified SI. However, the delivery of the modified SI for remote UE is incomplete and to be further developed.

### SUMMARY

In general, embodiments of the present disclosure provide methods, devices and computer storage media of communication for SI delivery through sidelink relay.

In a first aspect, there is provided a method of communication. The method comprises: receiving, at a first device and from a second device, information on modification of system information; determining modified system information to be transmitted to a third device based on a stored request for system information from the third device and the information on modification of system information; and transmitting the modified system information to the third device.

In a second aspect, there is provided a method of communication. The method comprises: transmitting, at a first device, an indication of a third device to a second device, the third device transmitting a request for system information to the first device; receiving, from the second device, modified system information with the indication of the third device; and forwarding the modified system information to the third device.

In a third aspect, there is provided a method of communication. The method comprises: transmitting, at a second device and to a first device, information on modification of system information for determination of modified system information to be transmitted to a third device based on a stored request for system information from the third device and the information on modification of system information.

In a fourth aspect, there is provided a method of communication. The method comprises: receiving, at a third device, modified system information from a first device, the modified system information being determined by a first device based on a stored request for system information from the third device and information on modification of system information from a second device.

In a fifth aspect, there is provided a device of communication. The device comprises a processor configured to perform the method according to the first or second aspect of the present disclosure.

In a sixth aspect, there is provided a device of communication. The device comprises a processor configured to perform the method according to the third aspect of the present disclosure.

In a seventh aspect, there is provided a device of communication. The device comprises a processor configured to perform the method according to the fourth aspect of the present disclosure.

In an eighth aspect, there is provided a computer readable medium having instructions stored thereon. The instructions, when executed on at least one processor, cause the at least one processor to perform the method according to the first or second aspect of the present disclosure.

In a ninth aspect, there is provided a computer readable medium having instructions stored thereon. The instructions, when executed on at least one processor, cause the at least one processor to perform the method according to the third aspect of the present disclosure.

In a tenth aspect, there is provided a computer readable medium having instructions stored thereon. The instructions, when executed on at least one processor, cause the at least one processor to perform the method according to the fourth aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which some embodiments of the present disclosure may be implemented;

FIG. 2A illustrates a schematic diagram illustrating a process for communication in SI delivery according to embodiments of the present disclosure;

FIG. 2B illustrates a schematic diagram illustrating an process for communication in delivery of modified SI according to embodiments of the present disclosure;

FIG. 2C illustrates a schematic diagram illustrating another process for communication in delivery of modified SI according to embodiments of the present disclosure;

FIG. 3A illustrates a schematic diagram illustrating a process for updating a SI request according to embodiments of the present disclosure;

FIG. 3B illustrates a schematic diagram illustrating another process for updating a SI request according to embodiments of the present disclosure;

FIG. 3C illustrates a schematic diagram illustrating still another process for updating a SI request according to embodiments of the present disclosure;

FIG. 4 illustrates a schematic diagram illustrating another process for communication in SI delivery according to embodiments of the present disclosure;

FIG. 5 illustrates a flowchart for an example method of communication implemented at a first device in accordance with some embodiments of the present disclosure;

FIG. 6 illustrates a flowchart for another example method of communication implemented at a first device in accordance with some embodiments of the present disclosure;

FIG. 7 illustrates a flowchart for an example method of communication implemented at a second device in accordance with some embodiments of the present disclosure;

FIG. 8 illustrates a flowchart for an example method of communication implemented at a third device in accordance with some embodiments of the present disclosure; and

FIG. 9 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present application, the term “remote UE” refers to a terminal device that is communicated with a network device via another terminal device in coverage of the network device. The term “relay UE” refers to a terminal device that is in coverage of a network device and via which remote UE is communication with the network device. The relay UE is connected with the remote UE via a sidelink interface such as a PC5 interface or the like. The term “remote UE” can be used interchangeably with a remote terminal device or a remote device. The term “relay UE” can be used interchangeably with a relay terminal device or a relay device.

As mentioned above, the delivery of modified SI for remote UE is incomplete. In view of this, embodiments of the present disclosure provide solutions for solving the above and other potential issues. In one aspect, there is provided a solution for delivering modified SI for remote UE based on a stored SI request from the remote UE. In this way, the modified SI for remote UE is determined by relay UE. In this case, relay UE may perform SI acquisition procedures when there is a real need to save power consumption and signaling overhead.

In another aspect, there is provided a solution for forwarding modified SI to remote UE based on an indication of the remote UE. In this way, the modified SI for remote UE is determined by a gNB. In this case, less complexity and memory requirement on relay UE may be achieved.

Principles and implementations of the present disclosure will be described in detail below with reference to the figures.

### Example of Communication Network

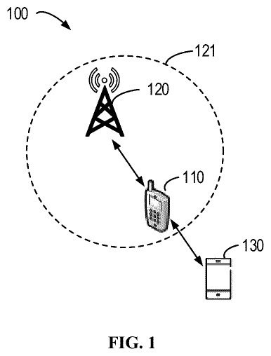

FIG. 1 illustrates a schematic diagram of an example communication network 100 in which some embodiments of the present disclosure can be implemented. As shown in FIG. 1, the communication network 100 may include a first device 110, a second device 120 and a third device 130. The second device 120 provides a cell 121 to serve one or more devices. In the example of FIG. 1, the first device 110 is located within the cell 121 of the second device 120, and the first device 110 may directly communicate with the second device 120. The third device 130 is located outside the cell 121. The third device 130 is connected with the first device 110 via a sidelink interface (for example, PC5 interface or the like) and may communicate with the second device 120 via the first device 110. In this case, the first device 110 is called as a relay device, and the third device 130 is called as a remote device.

In some embodiments, the first device 110 and the second device 120 may communicate with each other via a channel such as a wireless communication channel. The wireless communication channel may comprise a physical uplink control channel (PUCCH), a physical uplink shared channel (PUSCH), a physical random-access channel (PRACH), a physical downlink control channel (PDCCH), a physical downlink shared channel (PDSCH) and a physical broadcast channel (PBCH). Of course, any other suitable channels are also feasible.

In some embodiments, the first device 110 and the third device 130 may communicate with each other via a sidelink channel such as a physical sidelink shared channel (PSSCH), a physical sidelink control channel (PSCCH), a physical sidelink feedback channel (PSFCH) or the like.

The communications in the communication network 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

It is to be understood that the number of devices in FIG. 1 is given for the purpose of illustration without suggesting any limitations to the present disclosure. The communication network 100 may include any suitable number of first devices, second devices or third devices adapted for implementing implementations of the present disclosure.

For illustration, the first device 110 and the third device 130 are shown as terminal devices and the second device 120 is shown as a network device. Merely for illustration purpose and without suggesting any limitations as to the scope of the present disclosure, some embodiments will be described in the context where the first device 110 and the third device 130 are terminal devices and the second device 120 is a network device. In this case, the first device 110 corresponds to a relay UE, and the third device 130 corresponds to a remote UE.

It is to be understood that, in other embodiments, the first device 110 and/or the third device 130 may be a network device and the second device 120 may be a terminal device. In other words, the principles and spirits of the present disclosure can be applied to both uplink and downlink transmissions. Further, in some embodiments, all of the first device 110, the second device 120 and the third device 130 may be terminal devices, and in some embodiments, all of the first device 110, the second device 120 and the third device 130 may be network devices. The present application does not limit this aspect.

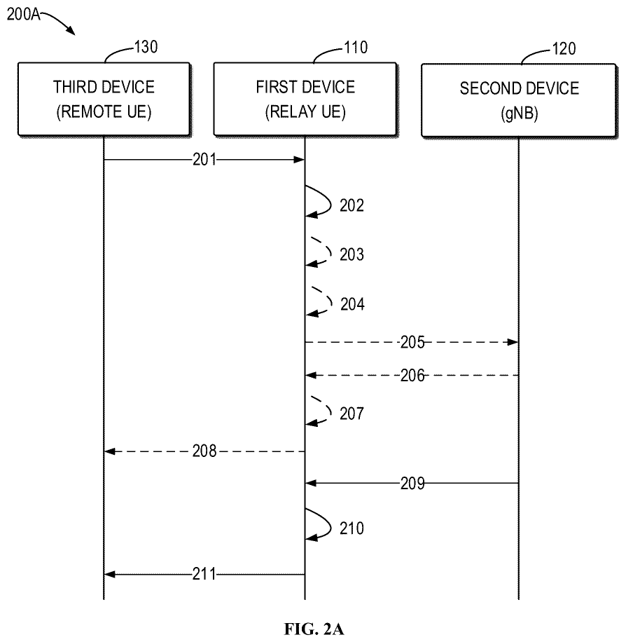

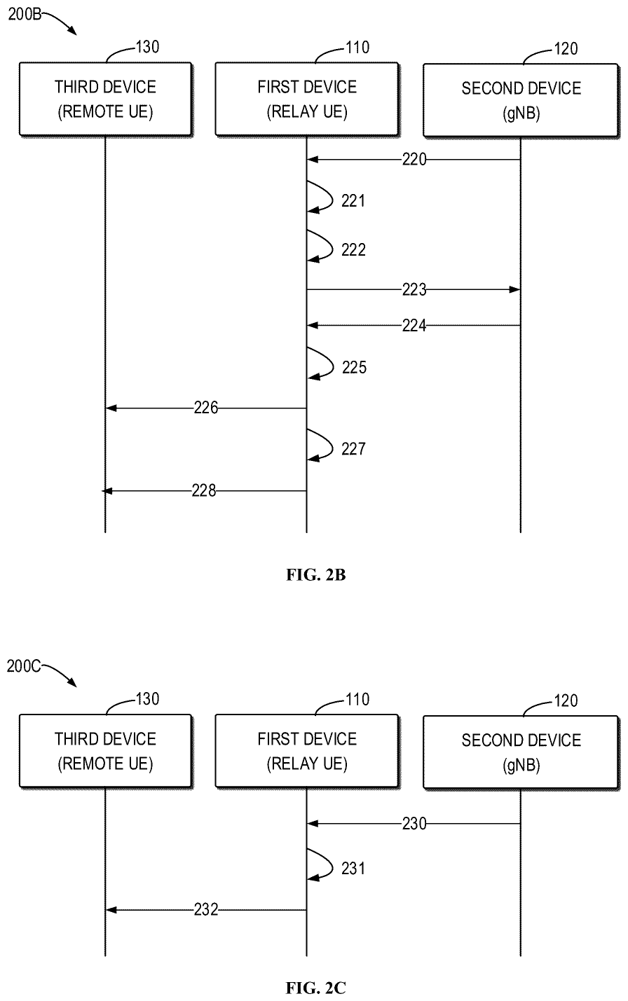

In some embodiments, the third device 130 may acquire modified SI (also referred to as changed SI herein) from the second device 120 via the first device 110. In some scenarios, the first device 110 may receive an indication of modified SI (also referred to as an SI change indication herein) from the second device 120. In some scenarios, the first device 110 may receive modified SI from the second device 120. Embodiments of the present disclosure provide solutions for delivering modified SI for these scenarios. The detailed description will be made below with reference to FIGS. 2A to 4.

### Example Implementation of SI Delivery with SI Request Stored

FIG. 2A illustrates a schematic diagram illustrating a process 200A for communication in SI delivery according to embodiments of the present disclosure. For the purpose of discussion, the process 200A will be described with reference to FIG. 1. The process 200A may involve the first device 110, the second device 120 and the third device 130 as illustrated in FIG. 1. For convenience, assuming that the first device 110 is relay UE, the second device 120 is a gNB, and the third device 130 is remote UE. It is to be understood that this is merely an example, and does not make limitation for the present disclosure. The steps and the order of the steps in FIG. 2A are merely for illustration, and not for limitation. For example, the order of the steps may be changed. Some of the steps may be omitted or any other suitable additional steps may be added.

As shown in FIG. 2A, the third device 130 transmits 201 a request for SI (also referred to as a SI request herein) to the first device 110. In some embodiments, the SI request may comprise a list of SI. For example, the SI request may comprise a requested-SI-List IE. The type of the requested-SI-List IE may be BIT STRING. The size of the maximum SI may be 32 bits. Of course, the list of SI may be carried in the SI request in any other suitable ways.

In some embodiments, the SI request may comprise a list of one or more system information blocks (SIBs) or SIB types. For example, the SI request may comprise a requestedSIB-List-r16 IE. The type of the requestedSIB-List-r16 IE may be SEQUENCE. Of course, the list of SIBs may be carried in the SI request in any other suitable ways.

In some embodiments, the SI request may comprise an identity (ID) of the third device 130. For example, the ID may be a layer-2 (L2) ID. As another example, the ID may be a cell-radio network temporary identifier (C-RNTI). As still another example, the ID may be an inactive-radio network temporary identifier (I-RNTI). It is to be understood that the ID may also adopt any other suitable forms.

It should be noted that the above examples are for illustration, and the SI request may also comprise a combination of the above information and/or any other suitable information or combination of information.

Upon receipt of the SI request, the first device 110 stores 202 the SI request. This facilitates subsequent determination of modified SI for the third device 130 based on the stored SI request. In some embodiments, the first device 110 may store the SI request in context of the third device 130.

In some alternative embodiments, the first device 110 may store the SI request in a variable. For example, the variable may be VarSIRqurest or VarSIBRequest. Of course, any other suitable forms are also feasible. In some embodiments, the SI request may be stored in associated with an ID of the third device 130. For example, if one variable for multiple remote UEs, IDs of the remote UEs may be used as indexes or entries to identify different UEs. In some embodiments, the SI request may be stored in associated with a type of the requested SI. For example, if one variable for multiple remote UEs, SI or SIB type of the requested SI by the remote UEs may be used as an index or entry and a list of one or more UE IDs is introduced per SI or SIB type to identify different UEs. It should be noted that the above examples are for illustration, and the SI request may be stored in any other suitable ways.

Based on the SI request from the third device 130, the first device 110 performs SI acquisition procedure. In some embodiments, the first device 110 may determine 203, whether a mapping from SI (e.g. SI message) to SIBs or from SIBs to SI is to be performed for the requested SI. The determination may be done based on a SI type in the SI request of remote UE and a SI type used by relay UE to require SI.

For example, if the SI request comprises a list of SIBs or SIB types but the first device 110 performs SI based scheme (such as MSG.1 based or MSG.3 based scheme) to acquire requested SI, the mapping may be determined to be performed. In this case, the mapping is from SIBs or SIB types to SI. If the SI request comprises a list of SIBs or SIB types and the first device 110 performs SIB based scheme (such as by transmitting a DedicatedSIBRequest message) to acquire requested SI, the mapping may be determined to be not performed.

As another example, if the SI request comprises a list of SI but the first device 110 performs SIB based scheme to acquire requested SI, the mapping may be determined to be performed. In this case, the mapping is from SI to SIBs or SIB types. If the SI request comprises a list of SI and the first device 110 performs SI based scheme, the mapping may be determined to be not performed. Of course, any other suitable ways may also feasible for the determination of the mapping.

If determining that the mapping is to be performed, the first device 110 may perform 204 the mapping for the requested SI so as to determine a mapped SI. In some embodiments, the mapped SI may comprise a list of SI. In some embodiments, the mapped SI may comprise a list of SIBs or SIB types. For example, the first device 110 may perform the mapping based on mapping information received from the second device 120 via SIB1 (e.g., SI-SchedulingInfo, SIB-Mapping). Of course, any other suitable forms are also feasible for the performance of the mapping.

Then the first device 110 may transmit 205 a request for acquiring the mapped SI to the second device 120. The second device 120 may transmit 206 the mapped SI to the first device 110. The first device 110 may determine 207 the requested SI from the mapped SI by performing an opposite mapping. For example, if the mapped SI is obtained by performing SI to SIB mapping, the first device 110 may determine the requested SI by performing SIB to SI mapping on the mapped SI acquired from the second device 120. If the mapped SI is obtained by performing SIB to SI mapping, the first device 110 may determine the requested SI by performing SI to SIB mapping on the mapped SI acquired from the second device 120. Then the first device 110 may transmit 208 the requested SI to the third device 130.

Subsequently, the first device 110 receives 209 information on modification of SI (also referred to as information on SI modification herein) from the second device 120. Based on the information on SI modification from the second device 120 and the stored SI request from the third device 130, the first device 110 determines 210 modified SI for the third device 130. Then the first device 110 transmits 211 the modified SI to the third device 130. The details of delivery of the modified SI will be described below in connection with Embodiments 1 and 2.

### Embodiment 1

In this embodiment, the information on SI modification may comprise an indication of SI modification (also referred to as a SI change indication herein). Delivery of the modified SI in this embodiment will be described below with reference to FIG. 2B.

FIG. 2B illustrates a schematic diagram illustrating a process 200B for communication in SI delivery according to embodiments of the present disclosure. For the purpose of discussion, the process 200B will be described with reference to FIG. 1. The process 200B may involve the first device 110, the second device 120 and the third device 130 as illustrated in FIG. 1. For convenience, assuming that the first device 110 is relay UE, the second device 120 is a gNB, and the third device 130 is remote UE. It is to be understood that this is merely an example, and does not make limitation for the present disclosure. The steps and the order of the steps in FIG. 2B are merely for illustration, and not for limitation. For example, the order of the steps may be changed. Some of the steps may be omitted or any other suitable additional steps may be added.

As shown in FIG. 2B, the second device 120 may transmit 220 an SI change indication to the first device 110. In this case, the first device 110 may acquire a set of modified SI from the second device 120, and determine the modified SI to be transmitted to the third device 130 from the set of modified SI based on the stored request. In some embodiments, the set of modified SI may comprise modified SI required for relay UE (i.e., the first device 110) and modified SI required for remote UE (e.g., the third device 130). In some embodiments, the set of modified SI may comprise modified SI required for multiple remote UEs. In some embodiments, the set of modified SI may comprise one or more SI. In some embodiments, the set of modified SI may comprise one or more SIBs.

In some embodiments, the first device 110 may determine 221 whether to acquire the set of modified SI from the second device 120. If the first device 110 determines to acquire the set of modified SI, the first device 110 acquires the set of modified SI. In some embodiments, the first device 110 may determine whether to acquire the set of modified SI based on at least one of the following: whether the third device 130 is out of coverage of the second device 120; whether the first device 110 is in a connected state or an inactive state; or whether the first device 110 requires the set of modified SI by itself; or whether the third device 130's request is stored. For example, the first device 110 may acquire the set of modified SI in response to at least one of the following: the third device 130 being out of coverage of the second device 120; the first device 110 being in a connected state; or the first device 110 requiring the set of modified SI.

As another example, the first device 110 may determine whether the third device 130's request is stored. If the third device 130's request is stored, the first device 110 may determine whether the first device 110 is in a connected state. If the first device 110 is in the connected state, the first device 110 may perform SI acquisition for the third device 130. If the first device 110 is not in the connected state or the third device 130's request is not stored, the first device 110 may perform SI acquisition according to its own need.

It is to be understood that these are merely examples, and the first device 110 may determine whether to acquire the set of modified SI based on any other suitable conditions. The present disclosure does not limit this aspect.

For acquisition of the set of modified SI, in some embodiments, the first device 110 may determine 222 a synthesized request based on stored SI requests from a set of remote UEs comprising the third device 130. In some embodiments, the set of remote UEs are out of coverage of the second device 120 and SI requests from the set of remote UEs are stored by the first device 110. In this way, the first device 110 may generate and transmit only one request for all SI requested by the set of remote UEs.

The first device 110 may transmit 223 the synthesized request to the second device 120. For example, the first device 110 may transmit a MSG3 (RRCSystemInfoRequest message) for the set of remote UEs. Of course, any other suitable forms are also feasible. In response to the synthesized request, the second device 120 may transmit 224 the set of modified SI indicated in the synthesized request to the second device 120.

It should be noted that although acquisition of the set of modified SI is described as being based on the synthesize request, the present disclosure is not limited to this. In some alternative embodiments, acquisition of the set of modified SI may be performed based on separate requests for respective remote UEs.

Upon receipt of the set of modified SI, the first device 110 may determine 225, from the set of modified SI, modified SI to be transmitted to the third device 130 based on the stored SI request from the third device 130. For example, the first device 110 may determine a subset of modified SI in the set of modified SI that corresponds to SI indicated in the stored SI request from the third device 130 and determine the subset of modified SI as the modified SI to be transmitted to the third device 130.

Then the first device 110 may transmit 226 the modified SI to the third device 130. In some embodiments, the first device 110 may determine 227 whether there is no SI request from a fourth device as a remote UE. The fourth device maintains a connection (e.g. PC5-RRC connection) with the first device 110. If there is no SI request from the fourth device, the first device 110 may forward 228 the SI change indication to the fourth device. For example, the first device 110 may forward the SI change indication to the fourth device via a PC5 RRC signaling. Of course, any other suitable ways are also feasible.

### Embodiment 2

In this embodiment, the information on SI modification may comprise a set of modified SI. Delivery of the modified SI in this embodiment will be described below with reference to FIG. 2C.

FIG. 2C illustrates a schematic diagram illustrating a process 200C for communication in SI delivery according to embodiments of the present disclosure. For the purpose of discussion, the process 200C will be described with reference to FIG. 1. The process 200C may involve the first device 110, the second device 120 and the third device 130 as illustrated in FIG. 1. For convenience, assuming that the first device 110 is relay UE, the second device 120 is a gNB, and the third device 130 is remote UE. It is to be understood that this is merely an example, and does not make limitation for the present disclosure. The steps and the order of the steps in FIG. 2C are merely for illustration, and not for limitation. For example, the order of the steps may be changed. Some of the steps may be omitted or any other suitable additional steps may be added.

As shown in FIG. 2C, the second device 120 may transmit 230 a set of modified SI to the first device 110. In some embodiments, the set of modified SI may comprise all SI or SIBs that are available for the second device 120. In some embodiments, the set of modified SI may comprise all SI or SIBs that are modified. In some embodiments, the set of modified SI may comprise SI or SIBs that are modified and are previously requested. For example, the set of modified SI comprise the SI or SIBs previously requested by all remote UEs which have PC5-RRC connection to the first device 110. For example, the set of modified SI comprise SI or SIBs previously requested by one remote UE which has PC5-RRC connection to the first device 110. In some embodiments, the set of modified SI comprise SI or SIBs previously requested by the first device 110.

Based on the stored request for the third device 130, the first device 110 may determine 231, from the set of modified SI, the modified SI to be transmitted to the third device 130. In other words, the first device 110 may perform SI filtering based on stored request for the third device 130. For example, the first device 110 perform SI filtering to select modified SI from the set of modified SI and each of the selected modified SI is indicated by the stored request. Then the first device 110 may transmit 232 the modified SI to the third device 130.

In this way, SI acquisition procedures are performed when needed and thus power consumption and signaling overhead is saved.

### Example Implementation of Updating of SI Request

Embodiments of the present disclosure also provide solutions for updating the stored SI request. These solutions will be described in connection with Embodiments 3 to 5.

### Embodiment 3

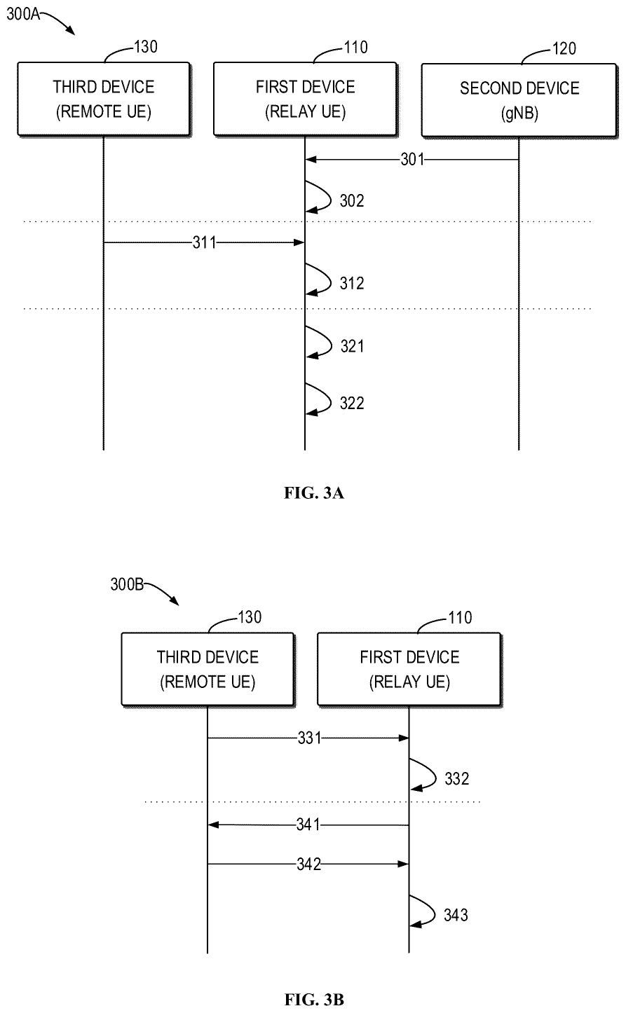

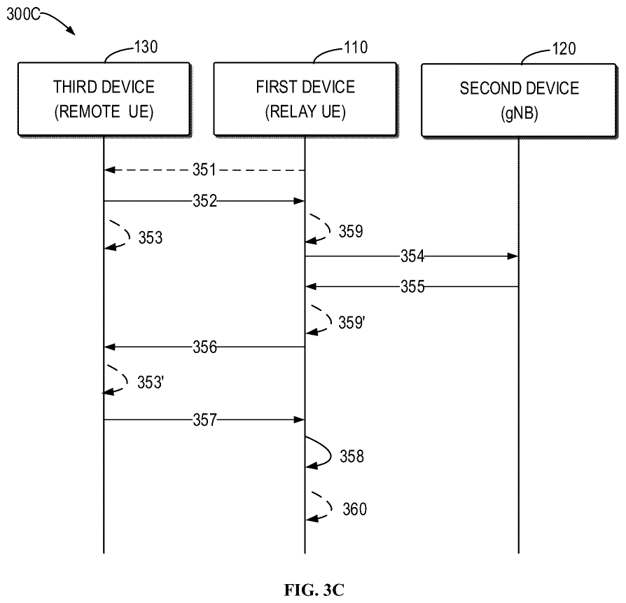

In this embodiment, the first device 110 may trigger updating of the stored SI request based on change of a state of the third device 130. Some example embodiments will be described with reference to FIG. 3A.

FIG. 3A illustrates a schematic diagram illustrating a process 300A for updating a SI request according to embodiments of the present disclosure. For the purpose of discussion, the process 300A will be described with reference to FIG. 1. The process 300A may involve the first device 110, the second device 120 and the third device 130 as illustrated in FIG. 1. For convenience, assuming that the first device 110 is relay UE, the second device 120 is a gNB, and the third device 130 is remote UE. It is to be understood that this is merely an example, and does not make limitation for the present disclosure. The steps and the order of the steps in FIG. 3A are merely for illustration, and not for limitation. For example, the order of the steps may be changed. Some of the steps may be omitted or any other suitable additional steps may be added.

As shown in FIG. 3A, in some embodiments, the second device 120 may transmit 301 a configuration such as a RRCReconfiguration message to the first device 110. In some embodiments, the configuration may indicate that the third device 130 enters into a connected state with the second device 120. In some embodiments, the configuration may indicate that the third device 130 changes from being out of coverage of the second device 120 into being in coverage of the second device 120. In some embodiments, the configuration may indicate that a connection between the first device 110 and the third device 130 is released. In some embodiments, the configuration may trigger that a connection between the first device 110 and the third device 130 to be released. Of course, the configuration may also comprise a combination of the above information or any other suitable information or combination of information. Upon receipt of such configuration, the first device 110 may delete 302 the stored SI request or the UE context which stores the SI request for the third device 130.

In some embodiments, the third device 130 may transmit 311 an indication regarding its state change to the first device 110. In some embodiments, the indication may indicate that the third device 130 enters into a connected state with the second device 120. In some embodiments, the indication may indicate that the third device 130 changes from being out of coverage of the second device 120 into being in coverage of the second device 120. In some embodiments, the indication may indicate that a connection between the first device 110 and the third device 130 is released. In some embodiments, the indication may trigger that a connection between the first device 110 and the third device 130 to be released. Of course, the indication may also comprise a combination of the above information or any other suitable information or combination of information. Upon receipt of such indication, the first device 110 may delete 312 the stored SI request or the UE context which stores the SI request for the third device 130.

In some embodiments, the third device 130 may detect 321 the third device 130's state change. In some embodiments, the third device 130 may determine whether the third device 130 enters into a connected state with the second device 120. In some embodiments, the third device 130 may determine whether the third device 130 changes from being out of coverage of the second device 120 into being in coverage of the second device 120. In some embodiments, the third device 130 may determine whether a connection between the first device 110 and the third device 130 is released. Of course, any other suitable ways are also feasible for the detection. Upon detection or determination of the third device's state change, the first device 110 may delete 322 the stored SI request or the UE context which stores the SI request for the third device 130.

In this way, an implicit scheme is provided to trigger updating of the stored SI request.

### Embodiment 4

In this embodiment, the first device 110 may trigger updating of the stored SI request based on change of SI requested by the third device 130. Some example embodiments will be described with reference to FIG. 3B.

FIG. 3B illustrates a schematic diagram illustrating another process 300B for updating a SI request according to embodiments of the present disclosure. For the purpose of discussion, the process 300B will be described with reference to FIG. 1. The process 300B may involve the first device 110, the second device 120 and the third device 130 as illustrated in FIG. 1. For convenience, assuming that the first device 110 is relay UE, the second device 120 is a gNB, and the third device 130 is remote UE. It is to be understood that this is merely an example, and does not make limitation for the present disclosure. The steps and the order of the steps in FIG. 3B are merely for illustration, and not for limitation. For example, the order of the steps may be changed. Some of the steps may be omitted or any other suitable additional steps may be added.

As shown in FIG. 3B, in some embodiments, the third device 130 may transmit 331, to the first device 110, a message indicating at least one of addition, deletion or reservation for SI indicated in the stored request (i.e., the requested SI). For example, the message may indicate that all requested SI are still needed. As another example, the message may indicate deletion of all previously request SI. As still another example, the message may indicate deletion of part of previously requested SI. Upon receipt of the message, the first device 110 may update 332 the stored request based on the message.

In some embodiments, the third device 130 may transmit a further SI request (i.e., another SI request) to the first device 110. The further SI request may indicate an addition of SI, i.e., request the SI or SIBs which are not previously requested. Upon receipt of the further SI request, the first device 110 may perform full replacement for the stored request with the further SI request. Alternatively, the first device 110 may store the SI or SIBs, which are not previously requested, indicated in the further SI request. For example, the first device 110 may add an entry for the latest requested SI in context of the third device 130 or in a variable for SI storage (e.g., VarSIRequest or VarSIBRequest).

In some alternative embodiments, the first device 110 may transmit 341 a request for confirming SI to the third device 130. For example, upon receipt of SI change indication, the first device 110 may transmit the request for confirming SI to the third device 130. It is to be understood that the transmission of the request for confirming SI may be performed in any other suitable ways, and is not limited to the above example. As another example, the request for confirming SI may indicate a list of SI or SIBs to be confirmed.

Upon receipt of the request for confirming SI, the third device 130 may transmit 342 a response to the request for confirming SI. In some embodiments, the response May indicate that SI indicated in the stored request is needed. In some embodiments, the response may indicate that SI indicated in the stored request is all deleted. In some embodiments, the response may indicate that a portion of SI indicated in the stored request is deleted. Based on the response, the first device 110 may update the stored request for the third device 130.

In this way, an explicit scheme is provided to trigger updating of the stored SI request.

### Embodiment 5

In this embodiment, the first device 110 may trigger updating of the stored SI request based on a timer-based scheme. Some example embodiments will be described with reference to FIG. 3C.

FIG. 3C illustrates a schematic diagram illustrating still another process 300C for updating a SI request according to embodiments of the present disclosure. For the purpose of discussion, the process 300C will be described with reference to FIG. 1. The process 300C may involve the first device 110, the second device 120 and the third device 130 as illustrated in FIG. 1. For convenience, assuming that the first device 110 is relay UE, the second device 120 is a gNB, and the third device 130 is remote UE. It is to be understood that this is merely an example, and does not make limitation for the present disclosure. The steps and the order of the steps in FIG. 3C are merely for illustration, and not for limitation. For example, the order of the steps may be changed. Some of the steps may be omitted or any other suitable additional steps may be added.

As shown in FIG. 3C, in some embodiments, the first device 110 may transmit 351 a configuration of a timer (e.g. the max duration or the max value) (for convenience, also referred to as a first timer herein) to the third device 130. In some embodiments, the third device 130 may transmit 352 a SI request to the first device 110, and may start 353 the first timer upon or after the transmission of the SI request.

In some embodiments, the first device 110 may transmit 354 a request for acquiring SI to the second device 120. As a result, the second device 120 may transmit 355 requested SI to the first device 110, and the first device 110 may forward 356 the requested SI to the third device 130. In some alternative embodiments, the third device 130 may start 353′ the first timer upon or after receipt of the requested SI from the first device 110.

In some embodiments, the first device 110 may transmit the configuration of the first timer to the third device 130 in a forwarding process of the requested SI from the first device 110 to the third device 130. For example, the configuration is transmitted along with the requested SI to the third device 130 (e.g. in the same IE of one RRC signaling, or in different IE of one RRC signaling, or in different RRC signalings) in the forward process as shown by 356. In these embodiments, the third device 130 may start 353 the first timer upon or after receipt of the requested SI from the first device 110.

Upon expiration of the first timer, the third device 130 may transmit 357, to the first device 110, a message indicating at least one of addition, deletion or reservation for SI indicated in the stored request. Upon receipt of the message, the first device 110 may update 358 the stored request for the third device 130.

It is to be understood that, although the foregoing description is made on that the first timer for the third device 130 is configured by the first device 110, the first timer may be predefined or preconfigured (e.g. via system information) in some alternative embodiments.

In some embodiments, the first device 110 may also start a timer (for convenience, also referred to as a second timer herein). In some embodiments, the second timer may be set differently from the first timer. In some embodiments, the second timer may be set in similar way as the first timer.

In some embodiments, the first device 110 may start 359 the second timer upon or after receipt of the SI request from the third device 130. In some alternative embodiments, the first device 110 may start 359′ the second timer upon or after forwarding of the requested SI to the third device 130. In alternative embodiments, the first device 110 may start 359′ the second timer upon or after forwarding of the SI request to the second device 130.

In some embodiments, upon expiration of the second timer, if no message indicating at least one of addition, deletion or reservation for system information indicated in the stored request is received from the third device 130, the first device 110 may delete 360 the stored request for the third device 130.

In this way, a timer-based scheme is provided to trigger updating of the stored SI request.

### Example Implementation of SI Delivery without SI Request Stored

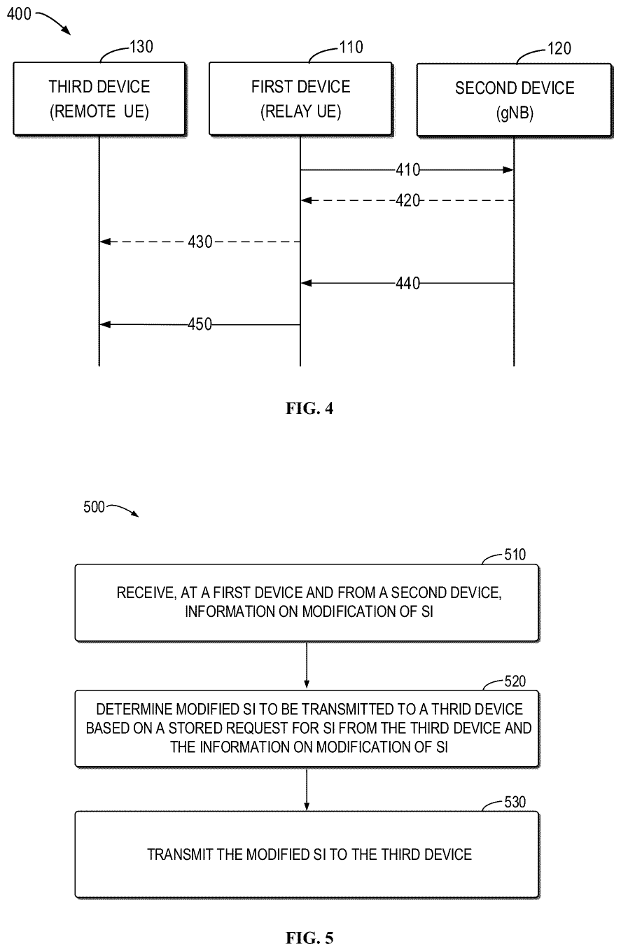

Embodiments of the present disclosure also provide a solution for SI delivery without SI request stored. This will be described in connection with FIG. 4.

FIG. 4 illustrates a schematic diagram illustrating a process 400 for communication in SI delivery according to embodiments of the present disclosure. For the purpose of discussion, the process 400 will be described with reference to FIG. 1. The process 400 may involve the first device 110, the second device 120 and the third device 130 as illustrated in FIG. 1. For convenience, assuming that the first device 110 is relay UE, the second device 120 is a gNB, and the third device 130 is remote UE. It is to be understood that this is merely an example, and does not make limitation for the present disclosure.

As shown in FIG. 4, the first device 110 transmits 410 an indication of the third device 130 to the second device 120. In some embodiments, the indication may comprise an ID of the third device 130. For example, the ID may be a L2 ID. As another example, the ID may be a C-RNTI. As still another example, the ID may be an I-RNTI. It is to be understood that the ID may also adopt any existing forms or any suitable forms future developed. In some embodiments, the indication may comprise a type of the third device 130. For example, the indication may indicate that the third device 130 is a remote UE. Of course, any other suitable attributes are also feasible for indicating the third device 130.

It is to be understood that the first device 110 may transmit the indication in any suitable ways. In some embodiments, the first device 110 may transmit the indication in a separate message. For example, the first device 110 may transmit the indication in a SidelinkUEInformationNR message. Of course, any other suitable messages are also feasible.

In some embodiments, the first device 110 may transmit, to the second device 120, the indication along with a request for acquiring SI from the second device 120. For example, the first device 110 may insert the indication in the header of a layer-2 (adaptation layer, or packet data convergence protocol (PDCP) layer, or radio link control (RLC) layer, or medium access control (MAC) layer) protocol data unit (PDU) which comprises the request for acquiring SI. In some embodiments, the first device 110 may insert the indication in the request for acquiring SI from the second device 120.

In some embodiments, the first device 110 may transmit the request for acquiring SI from the second device 120 via a resource associated with the third device 130. In this way, the third device 130 is indicated by the resource used for transmission of the request for acquiring SI. In some embodiments, the resource may comprise a logic channel associated with the third device 130. In some embodiments, the resource may comprise a resource pool associated with the third device 130. In some embodiments, the resource may comprise a physical random access channel (PRACH) preamble associated with the third device 130. In some embodiments, the resource may comprise a PRACH resource associated with the third device 130. Of course, any other suitable forms are also feasible for the resource.

Return to FIG. 4, the second device 120 may transmit 420 requested SI to the first device 110. The first device 110 may forward 430 the requested SI to the third device 130.

When there is modified SI, the second device 120 transmits 440, to the first device 110, the modified SI with the indication of the third device 130. In some embodiments, the modified SI may be associated with the indication of the third device 130. In some embodiments, the second device 120 may transmit a set of modified SI for a set of remote UEs, and modified SI in the set of modified SI is associated with corresponding indication of remote UE in the set of remote UE.

In some embodiments, the second device 120 may transmit the modified SI via a resource associated with the third device 130. In this way, the modified SI is indicated to be associated with the third device 130. In some embodiments, the resource may comprise a logic channel associated with the third device 130. In some embodiments, the resource may comprise a resource pool associated with the third device 130. In some embodiments, the resource may comprise a CORESET (control resource sets) associated with the third device 130. In some embodiments, the resource may comprise a search space associated with the third device 130. Of course, any other suitable forms are also feasible for the resource.

The first device 110 may forward 450 the modified SI to the third device 130. In other words, the first device 110 may forward modified SI corresponding to a remote UE to the remote UE.

With the solution of FIG. 4, complexity and memory requirement for relay UE may be required, and SI delivery may be achieved in a simple manner.

### Example Implementation of Methods

Accordingly, embodiments of the present disclosure provide methods of communication implemented at a remote UE, relay UE and a network device. These methods will be described below with reference to FIGS. 5 to 8.

FIG. 5 illustrates an example method 500 of communication implemented at a first device as a relay UE in accordance with some embodiments of the present disclosure. For example, the method 500 may be performed at the first device 110 as shown in FIG. 1. For the purpose of discussion, in the following, the method 500 will be described with reference to FIG. 1. It is to be understood that the method 500 may include additional blocks not shown and/or may omit some blocks as shown, and the scope of the present disclosure is not limited in this regard.

At block 510, the first device 110 receives information of modification of SI from the second device 120. In some embodiments, the information of modification of SI may comprise an indication of the modification of SI. In some embodiments, the information of modification of SI may comprise a set of modified SI.

In some embodiments, the first device 110 may also receive a request for SI from the third device 130 and store the request for SI. In some embodiments, the first device 110 may store the request in context of the third device 130. In some embodiments, the first device 110 may store, in a variable, the request in association with at least one of an ID of the third device 130 or a type of requested SI.

In some embodiments, the first device 110 may also acquire requested SI from the second device 120 and transmit the requested SI to the third device 130. In some embodiments, the requested SI may comprise at least one of a list of SI, a list of one or more SIBs, or an ID of the third device 130. In some embodiments, the first device 110 may determine whether a mapping from SI to a SIB or from a SIB to SI is to be performed for the requested SI. If the mapping is to be performed, the first device 110 may determine a mapped SI by performing the mapping for the requested SI, and acquire the mapped SI from the second device 120. Then the first device 110 may determine the requested SI from the mapped SI by performing a mapping from a SIB to SI or from SI to a SIB.

At block 520, the first device 110 determines modified SI to be transmitted to the third device 130 based on a stored request for SI from the third device 130 and the information on modification of SI from the second device 120.

In some embodiments where the information on modification of SI comprises an indication of the modification of SI, the first device 110 may acquire a set of modified SI from the second device 120, and determine the modified SI to be transmitted to the third device 130 from the set of modified SI based on the stored request. In some embodiments, the first device 110 may acquire the set of modified SI in response to at least one of the following: the third device 130 being out of coverage of the second device 120; the first device being in a connected state; or the first device requiring the set of modified SI. In some embodiments, the first device 110 may determine a synthesized request based on stored requests for SI from a set of devices, the set of devices comprising the third device 130. Then the first device 110 may transmit the synthesized request to the second device 120 and acquire the set of modified SI from the second device 120. In some embodiments, if no request for system information from a fourth device, the first device 110 may forward the indication of the modification of SI to the fourth device, the fourth device maintaining a connection with the first device 110.

In some embodiments where the information on modification of SI comprises a set of modified SI, the first device 110 may determine, from the set of modified SI, the modified SI to be transmitted to the third device 130 based on the stored request for the third device 130. In some embodiments, the set of modified SI may comprise SI or SIB that is modified. In some embodiments, the set of modified SI may comprise SI or SIB that is modified and is previously requested.

In some embodiments, the first device 110 may also update the stored request. In some embodiments, in response to receiving a configuration from the second device 120, the first device 110 may delete the stored request, the configuration indicating at least one of the following: the third device 130 enters into a connected state with the second device 120; the third device 130 changes from being out of coverage of the second device 120 into being in coverage of the second device 120; or a connection between the first device 110 and the third device 130 is released.

In some embodiments, in response to receiving an indication from the third device 130, the first device 110 may delete the stored request, the indication indicating at least one of the following: the third device 130 enters into a connected state with the second device 120; the third device 130 changes from being out of coverage of the second device 120 into being in coverage of the second device 120; or a connection between the first device 110 and the third device 130 is released.

In some embodiments, the first device 110 may delete the stored request in response to determining at least one of the following: the third device 130 enters into a connected state with the second device 120; the third device 130 changes from being out of coverage of the second device 120 into being in coverage of the second device 120; or a connection between the first device 110 and the third device 130 is released.

In some embodiments, the first device 110 may receive, from the third device 130, a message indicating at least one of addition, deletion or reservation for SI indicated in the stored request. Then the first device 110 may update the stored request based on the message. In some embodiments, the first device 110 may receive a further request for SI, the further request indicating the addition of SI, and update the stored request based on the further request. In these embodiments, the first device 110 may also acquire the added SI form the second device 120 and transmit the added SI to the third device 130.

In some embodiments, the first device 110 may also transmit a configuration of a first timer to the third device 130. In this way, the third device 130 may be caused to start the first timer and transmit, during running of the first timer, the message indicating at least one of addition, deletion or reservation for SI indicated in the stored request. In some embodiments, the first device 110 may transmit the configuration of the timer in a forwarding process of requested SI.

In some embodiments, the first device 110 may transmit, to the third device 130, a request for confirming SI. The first device 110 may receive, from the third device 130, a response to the request for confirming SI, and update the stored request based on the response. In some embodiments, the response may indicate one of the following: SI indicated in the stored request is needed; SI indicated in the stored request is all deleted; or a portion of the SI indicated in the stored request is deleted.

In some embodiments, the first device 110 may start a second timer upon or after forwarding of requested SI or receipt of the stored request for SI. If no message for indicating at least one of addition, deletion or reservation for SI indicated in the stored request is received from the third device 130 until the timer expires, the first device 110 may delete the stored request.

Upon determination of the modified SI at block 520, the first device 110 transmits the modified SI to the third device 130 at block 530.

With the method of FIG. 5, SI acquisition procedures are performed when needed and thus power consumption and signaling overhead is saved.

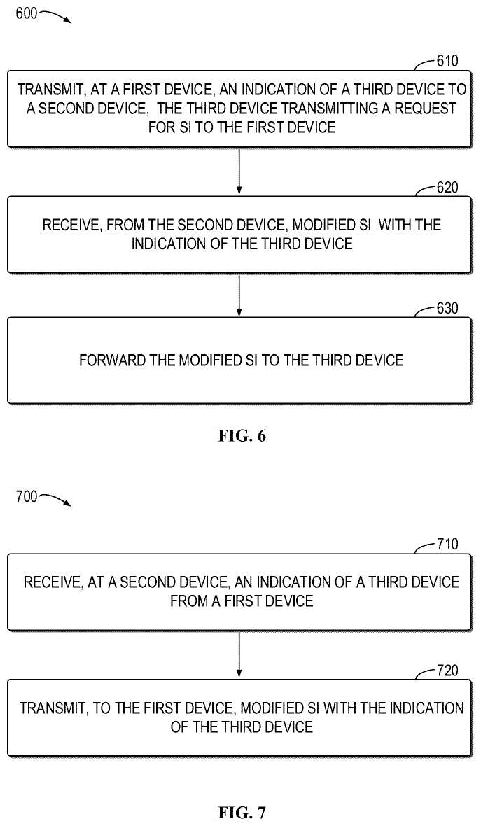

FIG. 6 illustrates another example method 600 of communication implemented at a first device as a relay UE in accordance with some embodiments of the present disclosure. For example, the method 600 may be performed at the first device 110 as shown in FIG. 1. For the purpose of discussion, in the following, the method 600 will be described with reference to FIG. 1. It is to be understood that the method 600 may include additional blocks not shown and/or may omit some blocks as shown, and the scope of the present disclosure is not limited in this regard.

At block 610, the first device 110 transmits an indication of the third device 130 to the second device 120. In some embodiments, the indication of the third device may comprise at least one of the following: an ID of the third device 130, or a type of the third device 130.

In some embodiments, the first device 110 may transmit, to the second device 120, the indication of the third device 130 along with a request for acquiring SI from the second device 120. In some embodiments, the first device 110 may transmitting the request for acquiring SI via a resource associated with the third device 130.

At block 620, the first device 110 may receive, from the second device 120, modified SI with the indication of the third device 130. At block 630, the first device 110 may forward the modified SI to the third device 130.

With the method of FIG. 6, complexity and memory requirement for relay UE may be required, and SI delivery may be achieved in a simple manner.

FIG. 7 illustrates an example method 700 of communication implemented at a second device as a network device in accordance with some embodiments of the present disclosure. For example, the method 700 may be performed at the second device 120 as shown in FIG. 1. For the purpose of discussion, in the following, the method 700 will be described with reference to FIG. 1. It is to be understood that the method 700 may include additional blocks not shown and/or may omit some blocks as shown, and the scope of the present disclosure is not limited in this regard.

As shown in FIG. 7, at block 710, the second device 120 receives an indication of the third device 130 from the first device 110. In some embodiments, the second device 120 may receive, from the first device 110, the indication of the third device 130 along with a request for acquiring SI. In some embodiments, the second device 120 may receive, from the first device 110, the request for acquiring SI via a resource associated with the third device 130. In some embodiments, the indication of the third device may comprise at least one of the following: an ID of the third device 130, or a type of the third device 130.

At block 720, the second device 120 transmits, to the first device 110, modified SI with the indication of the third device 130. In this way, it facilitates the first device 110 to forward modified SI corresponding to remote UE to the remote UE.

With the method 700, a delivery of modified SI for remote UE may be done in a simple manner.

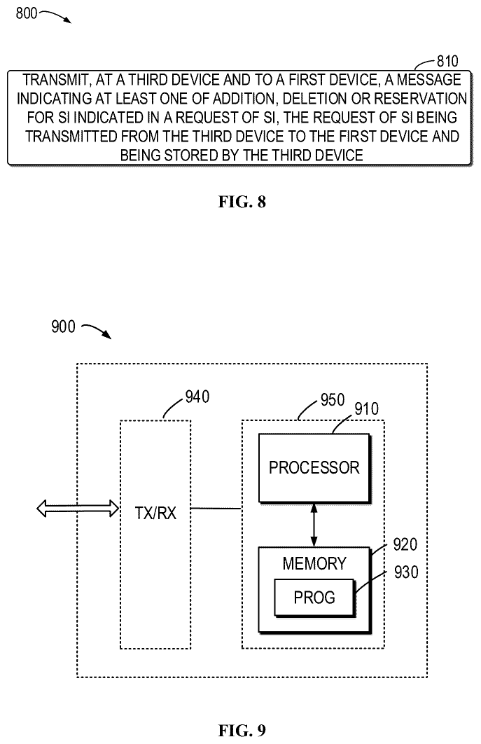

FIG. 8 illustrates an example method 800 of communication implemented at a third device as a remote UE in accordance with some embodiments of the present disclosure. For example, the method 800 may be performed at the third device 130 as shown in FIG. 1. For the purpose of discussion, in the following, the method 800 will be described with reference to FIG. 1. It is to be understood that the method 800 may include additional blocks not shown and/or may omit some blocks as shown, and the scope of the present disclosure is not limited in this regard.

As shown in FIG. 8, at block 810, the third device 130 transmits, to the first device 110, a message indicating at least one of addition, deletion or reservation for SI indicated in a request for SI. The request for SI is previously transmitted from the third device 130 to the first device 110 and being stored by the first device 110.

In some embodiments, the third device 130 may transmit a further request for SI to the third device 130 as the message, the further request indicating the addition of SI.

In some embodiments, the third device 130 may transmit an indication to the first device 110, the indication indicating at least one of the following: the third device 130 enters into a connected state with the second device 120; the third device 130 changes from being out of coverage of the second device 120 into being in coverage of the second device 120; or a connection between the first device 110 and the third device 130 is released. In this way, it facilitates updating of the stored request.

In some embodiments, the third device 130 may start a first timer upon or after transmission of a request for SI to the first device or receipt of requested SI from the first device 110, and transmit the message upon expiration of the first timer. In some embodiments, the third device 130 may receive a configuration of the first timer from the first device 110. In some embodiments, the first timer may be predefined.

In some embodiments, the third device 130 may receive a request for confirming SI from the first device 110, and transmit, to the first device 110, a response to the request for confirming SI. In some embodiments, the response may indicate that SI indicated in the stored request is needed. In some embodiments, the response may indicate that SI indicated in the stored request is all deleted. In some embodiments, the response may indicate that a portion of the SI indicated in the stored request is deleted.

With the method of FIG. 8, updating of a stored SI request for remote UE may be facilitated.

### Example Implementation of Device

FIG. 9 is a simplified block diagram of a device 900 that is suitable for implementing embodiments of the present disclosure. The device 900 can be considered as a further example implementation of the first device 110 or the second device 120 or the third device 130 as shown in FIG. 1. Accordingly, the device 900 can be implemented at or as at least a part of the first device 110 or the second device 120 or the third device 130.

As shown, the device 900 includes a processor 910, a memory 920 coupled to the processor 910, a suitable transmitter (TX) and receiver (RX) 940 coupled to the processor 910, and a communication interface coupled to the TX/RX 940. The memory 910 stores at least a part of a program 930. The TX/RX 940 is for bidirectional communications. The TX/RX 940 has at least one antenna to facilitate communication, though in practice an Access Node mentioned in this application may have several ones. The communication interface may represent any interface that is necessary for communication with other network elements, such as X2/Xn interface for bidirectional communications between cNBs/gNBs, S1/NG interface for communication between a Mobility Management Entity (MME)/Access and Mobility Management Function (AMF)/SGW/UPF and the cNB/gNB, Un interface for communication between the eNB/gNB and a relay node (RN), or Uu interface for communication between the eNB/gNB and a terminal device.

The program 930 is assumed to include program instructions that, when executed by the associated processor 910, enable the device 900 to operate in accordance with the embodiments of the present disclosure, as discussed herein with reference to FIGS. 2A to 8. The embodiments herein may be implemented by computer software executable by the processor 910 of the device 900, or by hardware, or by a combination of software and hardware. The processor 910 may be configured to implement various embodiments of the present disclosure. Furthermore, a combination of the processor 910 and memory 920 may form processing means 950 adapted to implement various embodiments of the present disclosure.

The memory 920 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 920 is shown in the device 900, there may be several physically distinct memory modules in the device 900. The processor 910 may be of any type suitable to the local technical network, and may include one or more of general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

In some embodiments, a first device comprises circuitry configured to: receive, from a second device, information on modification of system information; determine modified system information to be transmitted to a third device, based on a stored request for system information from the third device and the information on modification of system information; and transmit the modified system information to the third device.

In some embodiments, the circuitry may be further configured to: receive a request for system information from the third device; and store the request for system information. In some embodiments, the circuitry may be configured to store the request by at least one of the following: storing the request in context of the third device; or storing, in a variable, the request in association with at least one of an identity of the third device or a type of requested system information.

In some embodiments, the circuitry may be further configured to: acquire requested system information from the second device; and transmit the requested system information to the third device. In some embodiments, the requested system information may comprise at least one of the following: a list of system information, a list of one or more system information blocks, or an identity of the third device.

In some embodiments, the circuitry may be configured to acquire the system information by determining whether a mapping from system information to a system information block or from a system information block to system information is to be performed for the requested system information; in accordance with a determination that the mapping is to be performed, determining a mapped system information by performing the mapping for the requested system information; acquiring the mapped system information from the second device; and determining the requested system information from the mapped system information by performing a mapping from a system information block to system information or from system information to a system information block.

In some embodiments, the information on modification of system information comprises an indication of the modification of system information. In these embodiments, the circuitry may be configured to determine the modified system information to be transmitted by acquiring a set of modified system information from the second device; and determining the modified system information to be transmitted to the third device from the set of modified system information based on the stored request.

In some embodiments, the circuitry may be configured to acquire the set of modified system information in response to at least one of the following: the third device being out of coverage of the second device; the first device being in a connected state; or the first device requiring the set of modified system information.

In some embodiments, the circuitry may be configured to acquire the set of system information by determining a synthesized request based on stored requests for system information from a set of devices, the set of devices comprising the third device; transmitting the synthesized request to the second device; and acquiring the set of modified system information from the second device.

In some embodiments, the circuitry may be further configured to: in accordance with a determination that no request for system information from a fourth device, forward the indication of the modification of system information to the fourth device, the fourth device maintaining a connection with the first device.

In some embodiments, the information on modification of system information comprises a set of modified system information. In these embodiments, the circuitry may be configured to determine the modified system information by determining, from the set of modified system information, the modified system information to be transmitted to the third device based on the stored request for the third device. In these embodiments, the set of modified system information may comprise at least one of the following: system information or system information block that is modified, or system information or system information block that is modified and is previously requested.

In some embodiments, the circuitry may be further configured to update the stored request. In some embodiments, the circuitry may be configured to update the stored request by: in response to receiving a configuration from the second device, deleting the stored request, the configuration indicating at least one of the following: the third device enters into a connected state with the second device; the third device changes from being out of coverage of the second device into being in coverage of the second device; or a connection between the first device and the third device is released.

In some embodiments, the circuitry may be configured to update the stored request by: in response to receiving an indication from the third device, deleting the stored request, the indication indicating at least one of the following: the third device enters into a connected state with the second device; the third device changes from being out of coverage of the second device into being in coverage of the second device; or a connection between the first device and the third device is released.

In some embodiments, the circuitry may be configured to update the stored request by deleting the stored request in response to determining at least one of the following: the third device enters into a connected state with the second device; the third device changes from being out of coverage of the second device into being in coverage of the second device; or a connection between the first device and the third device is released.

In some embodiments, the circuitry may be configured to update the stored request by receiving, from the third device, a message indicating at least one of addition, deletion or reservation for system information indicated in the stored request; and updating the stored request based on the message.

In some embodiments, the circuitry may be configured to receive the message by receiving a further request for system information, the further request indicating the addition of system information. In these embodiments, the circuitry may be configured to update the stored request by updating the stored request based on the further request.

In some embodiments, the circuitry may be further configured to transmit a configuration of a first timer to the third device, wherein the message is transmitted by the third device during running of the first timer. In some embodiments, the circuitry may be further configured to transmit the configuration of the timer by transmitting the configuration of the timer in a forwarding process of requested system information.

In some embodiments, the circuitry may be configured to update the stored request by transmitting, to the third device, a request for confirming system information; receiving, from the third device, a response to the request for confirming system information; and updating the stored request based on the response. In some embodiments, the response may indicate one of the following: system information indicated in the stored request is needed; system information indicated in the stored request is all deleted; or a portion of the system information indicated in the stored request is deleted.

In some embodiments, the circuitry may be configured to update the stored request by starting a second timer upon or after forwarding of requested system information or receipt of the stored request for system information; and in accordance with a determination that no message for indicating at least one of addition, deletion or reservation for system information indicated in the stored request is received from the third device until the timer expires, deleting the stored request.

In some embodiments, a first device comprises circuitry configured to: transmit an indication of a third device to a second device; receive, from the second device, modified system information with the indication of the third device; and forward the modified system information to the third device.

In some embodiments, the circuitry may be configured to transmit the indication of the third device by transmitting, to the second device, the indication of the third device along with a request for acquiring system information from the second device. In some embodiments, the circuitry may be configured to transmit the indication of the third device by transmitting the request for acquiring system information via a resource associated with the third device. In some embodiments, the indication of the third device may comprise at least one of the following: an identity of the third device, or a type of the third device.

In some embodiments, a second device comprises circuitry configured to: receive an indication of a third device from a first device; and transmit, to the first device, modified system information with the indication of the third device.

In some embodiments, the circuitry may be configured to receive the indication of the third device by at least one of the following: receiving, from the first device, the indication of the third device along with a request for acquiring system information; or receiving the request for acquiring system information via a resource associated with the third device. In some embodiments, the indication of the third device may comprise at least one of the following: an identity of the third device, or a type of the third device.

In some embodiments, a third device comprises circuitry configured to: transmit, to a first device, a message indicating at least one of addition, deletion or reservation for system information indicated in a request for system information, the request for system information being transmitted from the third device to the first device and being stored by the first device.

In some embodiments, the circuitry may be further configured to transmit an indication to the first device, the indication indicating at least one of the following: the third device enters into a connected state with a second device; the third device changes from being out of coverage of the second device into being in coverage of the second device; or a connection between the first device and the third device is released.

In some embodiments, the circuitry may be configured to transmit the message by transmitting a further request for system information to the third device, the further request indicating the addition of system information.

In some embodiments, the circuitry may be configured to transmit the message by: starting a first timer upon or after transmission of a request for system information to the first device or receipt of requested system information from the first device; and transmitting the message upon expiration of the first timer.

In some embodiments, the circuitry may be further configured to receive a configuration of the first timer from the first device.

In some embodiments, the circuitry may be further configured to: receive a request for confirming system information from the first device; and transmit, to the first device, a response to the request for confirming system information. In some embodiments, the response may indicate one of the following: system information indicated in the stored request is needed; system information indicated in the stored request is all deleted; or a portion of the system information indicated in the stored request is deleted.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2A to 8. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

The invention claimed is:

1-42. (canceled)

43. A method of a relay User Equipment (UE), comprising:
receiving, from a remote UE, first information to indicate System Information Block (SIB), and
upon receiving, from network, the SIB indicated in the first information, initiating a transfer procedure related to the SIB to the remote UE.

44. The method of claim 43, further comprising:
receiving second information from the remote UE, wherein the remote UE enters a connected state with the network, and
releasing received SIB upon the reception of the second information.

45. The method of claim 43, wherein
the first information indicates a plurality of SIBs, and
upon receiving, from the network, the plurality of SIBs indicated in the first information, initiating the transfer procedure related to the plurality of SIBs to the remote UE.

46. The method of claim 43, wherein
the first information comprises requestedSIB-List Information Element (IE).

47. The method of claim 43, further comprising:
performing acquisition of system information after receiving the first information.

48. A relay User Equipment (UE) comprising:
a memory storing instructions and
a processor configured to execute the instructions to:
receive, from a remote UE, first information to indicate System Information Block (SIB), and
upon receiving, from network, the SIB indicated in the first information, initiate a transfer procedure related to the SIB to the remote UE.

49. The relay UE of claim 48, wherein the processor is further configured to execute the instruction to:
receive second information from the remote UE, wherein the remote UE enters a connected state with the network, and
release received SIB upon the reception of the second information.

50. The relay UE of claim 48, wherein
the first information indicates a plurality of SIBs, and
wherein the processor is further configured to execute the instruction to:
upon receiving, from the network, the plurality of SIBs indicated in the first information, initiate the transfer procedure related to the plurality of SIBs to the remote UE.

51. The relay UE of claim 48, wherein
the first information comprises requestedSIB-List Information Element (IE).

52. The relay UE of claim 48, wherein the processor is further configured to execute the instruction to:
perform acquisition of system information after receiving the first information.
